(19) United States
(12) Patent Application Publication
(10) Pub. No.: US 2025/0191351 A1
(43) Pub. Date: Jun. 12, 2025

(54) INFORMATION PROCESSING SYSTEM, INFORMATION PROCESSING METHOD, AND PROGRAM

(71) Applicant: Sony Interactive Entertainment Inc., Tokyo (JP)

(72) Inventor: Shogo Sato, Tokyo (JP)

(73) Assignee: Sony Interactive Entertainment Inc., Tokyo (JP)

(21) Appl. No.: 18/845,955

(22) PCT Filed: Apr. 6, 2022
(86) PCT No.: PCT/JP2022/017176

§ 371 Date: Sep. 11, 2024

(51) Int. Cl. G06V 10/776; G06V 10/75; G06V 10/77; G06V 10/82

(52) U.S. Cl. CPC G06V 10/776; G06V 10/75; G06V 10/7715; G06V 10/82

(57) ABSTRACT

Degradation of the accuracy in subsequent processing caused by a difference in image capturing conditions is suppressed. An information processing system acquires a first image in which a subject is captured under a first image capturing condition, acquires a second image in which the subject is captured under a second image capturing condition, extracts a first feature value indicative of a feature of the first image and a second feature value indicative of a feature of the second image converted by an image conversion unit that is a machine learning model to which the acquired second image is inputted and which outputs a converted second image, and trains the image conversion unit in reference to a difference in characteristics between the first feature value and the second feature value in regard to a plurality of subjects.

### TECHNICAL FIELD

The present invention relates to an information processing system, an information processing method, and a program.

### BACKGROUND ART

In recent years, image processing using a machine learning model is in widespread use. For example, information indicating a captured image is inputted to the machine learning model, and the machine learning model outputs some result.

### SUMMARY

### Technical Problem

For example, in a case where a camera that has captured an image to be used when a machine learning model is trained and a camera that captures an image to be inputted to the trained machine learning model are different from each other or in a like case, expected is a case in which characteristics of images are different from each other due to difference in condition for image capturing upon training and upon inference. In such a case, there is a possibility that accuracy of the output of a machine learning model may degrade.

The present invention has been made in view of the problem described above, and it is an object of the present invention to provide a technology by which, in a case where an image captured under a certain image capturing condition and another image captured under some other image capturing condition are processed with use of the same method including the same machine learning model, for example, degradation of accuracy of the processing is suppressed.

### Solution to Problem

In order to solve the problem described above, the information processing system according to the present invention includes a first image acquisition unit that acquires a first image in which a subject is captured under a first image capturing condition, a second image acquisition unit that acquires a second image in which the subject is captured under a second image capturing condition, an image conversion unit that is a machine learning model to which the acquired second image is inputted and which outputs a converted second image, an extraction unit that extracts a first feature value indicative of a feature of the first image and a second feature value indicative of a feature of the converted second image from the second image converted by the image conversion unit, and a conversion training unit that trains the image conversion unit in reference to a difference in characteristics between the first feature value and the second feature value in regard to a plurality of subjects.

In one aspect of the present invention, the first image capturing condition may be image capturing using a first camera, and the second image capturing condition may be image capturing using a second camera having a characteristic different from that of the first camera.

In the one aspect of the present invention, the conversion training unit may train the image conversion unit in reference to a difference between a correct answer and a value outputted, when the first feature amount or the second feature amount is inputted to an identifier, from the identifier that is trained with learning data including a plurality of pieces of input data each including one of the first feature value and the second feature value and correct answer data indicative of which one of the first feature value and the second feature value each piece of the input data is.

In the one aspect of the present invention, the information processing system may further include a processing unit that inputs a feature value extracted by the extraction unit from the image captured under the second image capturing condition and converted by the image conversion unit to a machine learning model trained in reference to a feature value extracted by the extraction unit from the image captured under the first image capturing condition and executes a process in reference to an output of the machine learning model in regard to the inputted feature value.

In the one aspect of the present invention, the machine learning model may output information indicative of whether or not the image captured under the second image capturing condition and converted by the image conversion unit includes a predetermined object.

Further, the information processing method according to the present invention includes steps of acquiring a first image in which a subject is captured under a first image capturing condition, acquiring a second image in which the subject is captured under a second image capturing condition, extracting a first feature value indicative of a feature of the first image and a second feature value indicative of a feature of the second image converted by an image conversion unit that is a machine learning model to which the acquired second image is inputted and which outputs a converted second image, and training the image conversion unit in reference to a difference in characteristics between the first feature value and the second feature value in regard to a plurality of subjects.

Further, the program according to the present invention causes a computer to execute processing of acquiring a first image in which a subject is captured under a first image capturing condition, acquiring a second image in which the subject is captured under a second image capturing condition, extracting a first feature value indicative of a feature of the first image and a second feature value indicative of a feature of the second image converted by an image conversion unit that is a machine learning model to which the acquired second image is inputted and which outputs a converted second image, and training the image conversion unit in reference to a difference in characteristics between the first feature value and the second feature value in regard to a plurality of subjects.

### Advantageous Effect of Invention

With the present invention, in a case where an image captured under a certain image capturing condition and another image captured under some other image capturing condition are processed with use of the same method including the same machine learning model, for example, degradation of accuracy of the processing can be suppressed.

### BRIEF DESCRIPTION OF DRAWINGS

FIG. 1 is a diagram depicting an example of a configuration of an information processing system according to an embodiment of the present invention.

FIG. 2 is a functional block diagram depicting an example of functions to be incorporated in the information processing system according to the embodiment of the present invention.

FIG. 3 is a functional block diagram depicting another example of functions to be incorporated in the information processing system according to the embodiment of the present invention.

FIG. 4 is a flow chart schematically depicting processing for training an image conversion unit.

FIG. 5 is a view depicting an example of a captured image.

FIG. 6 is a flow chart depicting an example of processing for training a camera identifier.

FIG. 7 is a flow chart depicting an example of processing for training the image conversion unit.

FIG. 8 is a flow chart depicting an example of a training process of an object identification model based on a first camera.

FIG. 9 is a flow chart depicting an example of an inference process based on a second camera.

### DESCRIPTION OF EMBODIMENT

In the following description, an embodiment of the present invention is described in detail with reference to the drawings. The present embodiment is described in connection with a case in which the present invention is applied to an information processing system to which an image in which an object used as a subject is captured is inputted and which determines whether or not a target object is included in the image.

This information processing system uses a machine learning model in order to determine whether or not an image includes a target object. Further, a condition for capturing an image that is to be made a target of determination at the time of inference (for example, a camera for image capturing) is different from a condition for capturing an image that is to be included in training data of a machine learning model. In the following description, an information processing system which is so configured as to be ready for such a difference in condition for image capturing as just described, especially for a camera difference, is described.

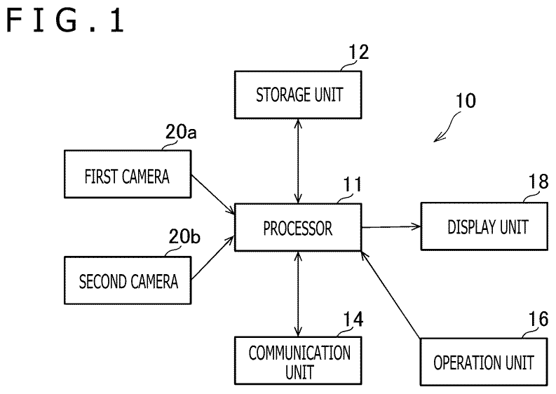

FIG. 1 is a diagram depicting an example of a configuration of an information processing system according to an embodiment of the present invention. The information processing system according to the present embodiment includes an information processing apparatus 10. The information processing apparatus 10 is, for example, a computer such as a game console or a personal computer. As depicted in FIG. 1, the information processing apparatus 10 includes, for example, a processor 11, a storage unit 12, a communication unit 14, an operation unit 16, a display unit 18, a first camera 20a, and a second camera 20b. The information processing system may be configured from one information processing apparatus 10 or may be configured from a plurality of apparatuses including the information processing apparatus 10.

The processor 11 is, for example, a program-controlled device such as a central processing unit (CPU) that operates in accordance with a program installed in the information processing apparatus 10.

The storage unit 12 includes at least some of storage elements such as a read only memory (ROM) and a random access memory (RAM) and external storage devices such as a solid state drive. A program to be executed by the processor 11 and so forth are stored in the storage unit 12.

The communication unit 14 is a communication interface for wired communication or wireless communication such as a network interface card, for example, and performs transmission and reception of data to and from some other computer or terminal through a computer network such as the Internet.

The operation unit 16 is an inputting device such as a keyboard, a mouse, a touch panel, or a controller of a game console, for example, and accepts an operation input made by a user and outputs a signal indicative of contents of the accepted operation to the processor 11.

The display unit 18 is a display device such as a liquid crystal display and displays various images thereon in accordance with an instruction from the processor 11. The display unit 18 may be a device that outputs a video signal to an external display device.

The first camera 20a and the second camera 20b are image capturing devices each including a capturing element and are, for example, cameras capable of capturing a moving image. The first camera 20a and the second camera 20b may each be a camera capable of acquiring a visible RGB image. The first camera 20a and the second camera 20b may be cameras capable of acquiring a visible RGB image and depth information synchronized with the RGB images.

The first camera 20a and the second camera 20b are different from each other in characteristics. As the characteristics, a plurality of items are available including, for example, a gamma characteristic, a distortion of an image, an F value, a focal distance, and presence or absence of an image stabilization function, and at least one of the items is different between the first camera 20a and the second camera 20b. At least one of the first camera 20a and the second camera 20b may be provided outside the information processing apparatus 10 or may be built in some other computer. At least one of the first camera 20a and the second camera 20b may be connected to the information processing apparatus 10 through the communication unit 14 or an inputting and outputting unit hereinafter described.

It is to be noted that the information processing apparatus 10 may include sound inputting and outputting devices such as a microphone and a speaker. Further, the information processing apparatus 10 may include, for example, a communication interface such as a network board, an optical disk drive for reading an optical disk such as a digital versatile disc (DVD)-ROM or a Blu-ray (registered trademark) disk, or an inputting and outputting unit (universal serial bus (USB) port) for inputting and outputting data to and from an external apparatus.

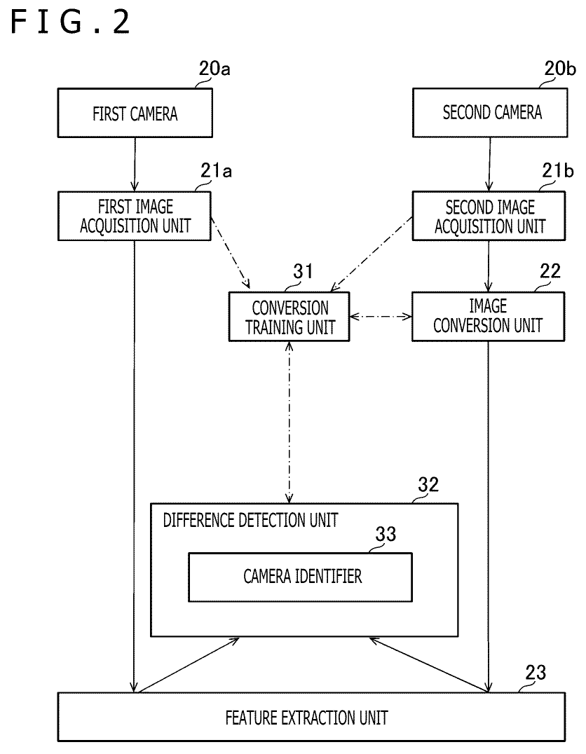

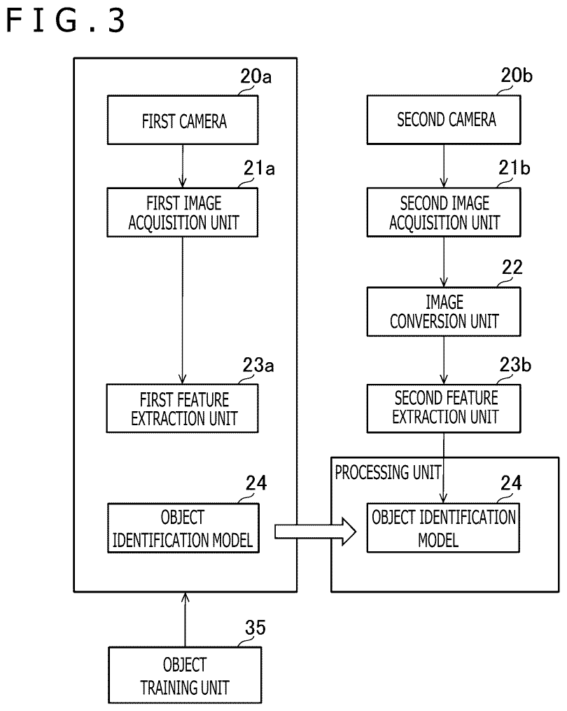

FIGS. 2 and 3 are functional block diagrams depicting examples of functions to be incorporated in the information processing system according to the embodiment of the present invention. FIG. 2 depicts functions for training an image conversion unit 22 for coping with a camera difference, and FIG. 3 depicts functions for training an object identification model 24 with use of the trained image conversion unit 22 and identifying an image with use of the object identification model 24.

As depicted in FIGS. 2 and 3, the information processing system functionally includes a first image acquisition unit 21a, a second image acquisition unit 21b, the image conversion unit 22, a feature extraction unit 23, a first feature extraction unit 23a, a second feature extraction unit 23b, the object identification model 24, a conversion training unit 31, a difference detection unit 32, and an object training unit 35. The difference detection unit 32 includes a camera identifier 33 that is one kind of a machine learning model. The object identification model 24 is an example of a processing unit that executes processing according to an output of the second feature extraction unit 23b.

The functions are incorporated principally by the processor 11 and the storage unit 12. More particularly, the functions may be incorporated by the processor 11 executing a program that is installed in the information processing apparatus 10, which is a computer, and that includes execution commands corresponding to the functions described above. Further, the program may be supplied to the information processing apparatus 10 through a computer-readable information recording medium such as an optical disk, a magnetic disk, or a flash memory, for example, or through the Internet or the like.

It is to be noted that the information processing system according to the present embodiment may not necessarily have all of the functions depicted in FIG. 2 incorporated therein and may have functions other than the functions depicted in FIG. 2 incorporated therein.

The first image acquisition unit 21a acquires a first image captured by the first camera 20a. In the present embodiment, the first image principally is an image in which at least one of a plurality of objects is captured. It is to be noted that an object is an example of a subject, and the first image may be an image in which a subject of a different type, for example, a subject having no clear shape, is captured. In the following description, unless otherwise specified, an image in which an object is captured may be an image in which a subject of a different type is captured.

The second image acquisition unit 21b acquires a second image captured by the second camera 20b. In the present embodiment, the second image principally is an image in which an object same as that of the first image is captured.

The image conversion unit 22 outputs, when a second image is inputted thereto, a converted second image. The image conversion unit 22 is a machine learning model. Details of a method of training the image conversion unit 22 are described later.

The feature extraction unit 23 extracts, from each of a plurality of images including a first image and a converted second image, a feature value indicative of a feature of the image. It is to be noted that, in the following description, a feature value extracted from the first image is referred to as a first feature value, and a feature value extracted from the second image is referred to as a second feature value. The first feature extraction unit 23a extracts, from the first image, the first feature value indicative of a feature of the first image. The second feature extraction unit 23b extracts, from the second image converted by the image conversion unit 22, the second feature value indicative of a feature of the converted second image. The entities of the feature extraction unit 23, the first feature extraction unit 23a, and the second feature extraction unit 23b may be the same one or may be arranged in computers different from each other. Even if the feature extraction unit 23, the first feature extraction unit 23a, and the second feature extraction unit 23b are arranged in computers different from each other, they extract a feature value by the same method.

The difference detection unit 32 detects a difference in characteristics between the first feature value and the second feature value in regard to a plurality of objects. The camera identifier 33 included in the difference detection unit 32 is trained with training data including a plurality of pieces of input data each including one of the first feature value and the second feature value and correct answer data indicative of which one of the first feature value and the second feature value each piece of the input data is. The difference detection unit 32 detects, as a difference in characteristics, a difference between a correct answer and a value outputted from the camera identifier 33 when a first feature value or a second feature value is inputted thereto.

The conversion training unit 31 trains the image conversion unit 22 in reference to a result of detection of a difference in characteristics by the difference detection unit 32.

The object identification model 24 is a support vector machine (SVM) or the like and is a kind of a machine learning model. The object identification model 24 is trained with a feature value extracted by the first feature extraction unit 23a from an image captured by the first camera 20a. In the present embodiment, the object identification model 24 outputs, in reference to a feature value extracted by the second feature extraction unit 23b from an image captured by the second camera 20b and converted by the trained image conversion unit 22, information indicative of whether or not the image is an image that includes a target object.

More specifically, the object identification model 24 outputs, in response to an input thereto of data indicative of a feature value corresponding to an image, an identification score indicative of a probability that an object included in the image belongs to a positive class in the object identification model 24. The object identification model 24 is trained with a plurality of pieces of positive example training data concerning a positive example and a plurality of pieces of negative example training data concerning a negative example. The positive example training data is generated by the first feature extraction unit 23a from a positive example image including an image in which a target object is captured, and the negative example training data is generated by the first feature extraction unit 23a from a negative example image of an object different from the target object. The positive example image may be an image captured by the first camera 20a, and the negative example image may be an image of an environment of the first camera 20a captured by the first camera 20a. It is to be noted that the positive example image may be an image captured by the second camera 20b and converted by the image conversion unit 22.

Here, the first feature extraction unit 23a includes a trained convolutional neural network (CNN). This CNN outputs, in response to an input of an image thereto, data indicative of a feature value corresponding to the image. For the CNN of the first feature extraction unit 23a, metric learning is executed in advance. By the metric learning performed in advance, images in which an object belonging to a positive class in the object identification model 24 is captured are tuned such that pieces of feature value data indicative of feature values close to each other are output. The feature value according to the present embodiment is, for example, a vector value normalized such that the norm is 1. It is to be noted that the metric learning may be performed before capturing of an image of a target object.

By use of a CNN for which metric learning is executed in advance, feature values of samples belonging to one class are consolidated to a compact region without depending on a condition. As a result, the information processing apparatus 10 according to the present embodiment can determine a reasonable identification boundary of the object identification model 24 even from a small number of samples. Consequently, training of the object identification model 24 is completed in a short period of time. The required time is assumed, for example, to be several ten seconds for recognizing and rotating an object for the acquisition of a positive example image and approximately several seconds for machine learning.

Although it is preferable in the present embodiment to perform metric learning for the CNN in order to ensure the overall accuracy, this is not essential. The first feature extraction unit 23a may output, in response to an input of an image, data indicative of a feature value corresponding to the image by some other known algorithms for calculating a feature value indicative of a feature of an image.

The object training unit 35 trains the object identification model 24 with training data. The training data of the object identification model 24 includes a feature value of a plurality of positive examples and a feature value of a plurality of negative examples. The feature value of a plurality of negative examples is extracted by the first feature extraction unit 23a from a plurality of negative example images that are captured by the first camera 20a and that do not include a target object. The feature value of a plurality of positive examples is extracted by the first feature extraction unit 23a from a plurality of positive example images including an image in which a target object is captured by the first camera 20a. The feature value of a positive example may be extracted by the first feature extraction unit 23a or the second feature extraction unit 23b from a positive example image converted by the image conversion unit 22 from an image in which a target object is captured by the second camera 20b.

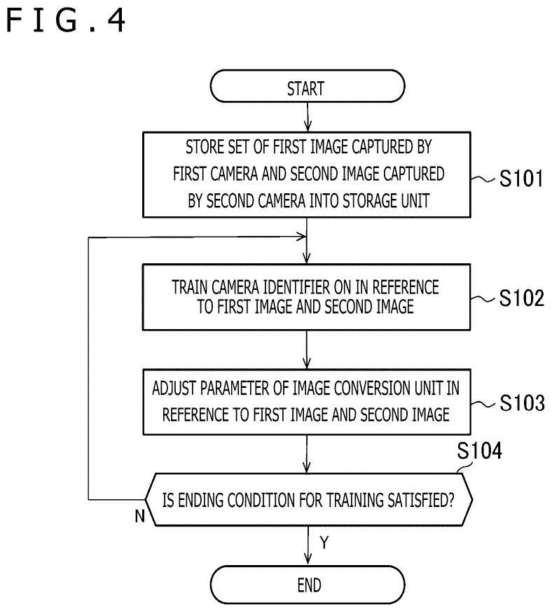

Now, processing of training of the image conversion unit 22 is described. In the present embodiment, the image conversion unit 22 is trained by a method of generative adversarial network in which the camera identifier 33 is a discriminator. FIG. 4 is a flow chart schematically depicting processing for training the image conversion unit 22.

First, the conversion training unit 31 stores a set of a first image captured by the first camera 20a and a second image captured by the second camera 20b into the storage unit 12 (S101). A plurality of sets are stored into the storage unit 12. Each of the sets includes a first image and a second image. The first image and the second image included in the same set are images in which the same object is captured. The plurality of sets include images in which a plurality of objects are captured individually. The conversion training unit 31 acquires the first image from the first image acquisition unit 21a and acquires the second image from the second image acquisition unit 21b.

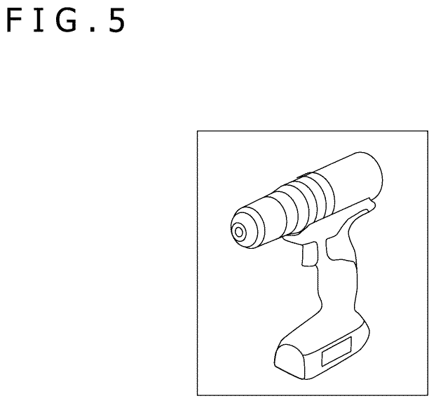

FIG. 5 is a view depicting an example of a captured image. In FIG. 5, an image in which a tool as an example of an object is captured is depicted. FIG. 5 is an example of the first image or the second image. The first image acquisition unit 21a may acquire the overall area of an image captured by the first camera 20a as the first image or may acquire part of an image captured by the first camera 20a as the first image.

In the latter case, the first image acquisition unit 21a may input an image captured by the first camera 20a to a Regional Proposal Network (RPN) trained in advance and acquire, as the first image, a region of the image estimated by the RPN that some object exists therein. Similarly, the second image acquisition unit 21b may acquire, as the second image, part of the area or the overall area of an image captured by the second camera 20b. Alternatively, the second image acquisition unit 21b may acquire, as the second image, a region estimated by an RPN trained in advance that some object exists therein.

After a plurality of sets are stored into the storage unit 12, the conversion training unit 31 trains the camera identifier 33 in reference to the first images and the second images included in the plurality of sets (S102). Meanwhile, the conversion training unit 31 adjusts, on the basis of the first images and the second images, a parameter of the image conversion unit 22 such that the first images and the second images may not be identified by the camera identifier 33 (S103).

Further, in a case where an ending condition for training determined in advance is not satisfied (N in S104), the conversion training unit 31 repeats the processes beginning with S102. In a case where the ending condition for training determined in advance is satisfied (Y in S104), the conversion training unit 31 ends the processing. The ending condition for training may be a mere number of times of repetition or may be detection of a state in which the rate of change of the parameter is lower than a threshold value, for over the last predetermined number of times.

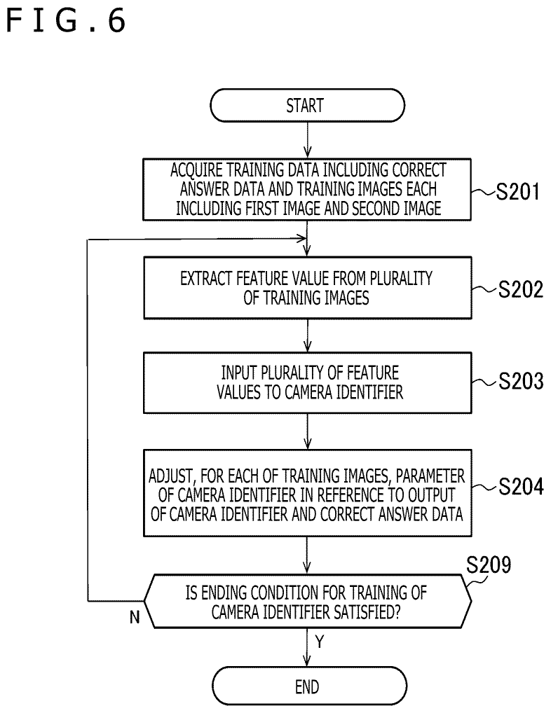

The process in S102 is described in more detail. FIG. 6 is a flow chart depicting an example of processing for training the camera identifier 33. The conversion training unit 31 trains the camera identifier 33 such that the camera identifier 33 can identify an image captured by the first camera 20a. It is to be noted that information indicative of which one of a first image and a second image the inputted image is is not inputted to the camera identifier 33 itself.

First, the conversion training unit 31 acquires, from the plurality of sets stored in the storage unit 12, training data including correct answer data and training images including a plurality of first images and a plurality of second images (S201). The correct answer data is data indicative of which one of the first image and the second image the training image is.

After the training data including the training images are acquired, the first feature extraction unit 23a or the second feature extraction unit 23b extracts a feature value from each of the plurality of training images (S202). The conversion training unit 31 inputs the extracted feature values to the camera identifier 33 (S203). The conversion training unit 31 adjusts, for each of the training images, the parameter of the camera identifier 33 in reference to an output of the camera identifier 33 and the correct answer data (S204).

The conversion training unit 31 adjusts the parameter of the camera identifier 33 in reference to the output of the camera identifier 33 and the correct answer data (S204). The conversion training unit 31 updates, in the adjustment of the parameter, the parameter such that the Binary Cross Entropy between the output of the camera identifier 33 and a true value is minimized. It is to be noted that the parameter may be updated by some other method such as the Mean Squared Error, for example.

After the parameter is adjusted, the conversion training unit 31 determines whether or not an ending condition for training of the camera identifier 33 is satisfied (S209). In a case where the ending condition is not satisfied (N in S209), the processes beginning with S202 are repeated, but in a case where the ending condition is satisfied (Y in S209), the processing of FIG. 6 is ended. It is to be noted that the ending condition may be that the number of times of repetition of the processing becomes equal to a number (Epoch number) determined in advance, or the ending condition may be that the correct answer rate of the camera identifier 33 with respect to input data for a test exceeds a threshold value. It is to be noted that the conversion training unit 31 may store the feature value extracted in S202 into the storage unit 12 such that, in the processing for the second and subsequent times, the feature value stored in the storage unit 12 instead of the process in S202 being performed. In this case, only the processes in S203 and S204 may be repeated.

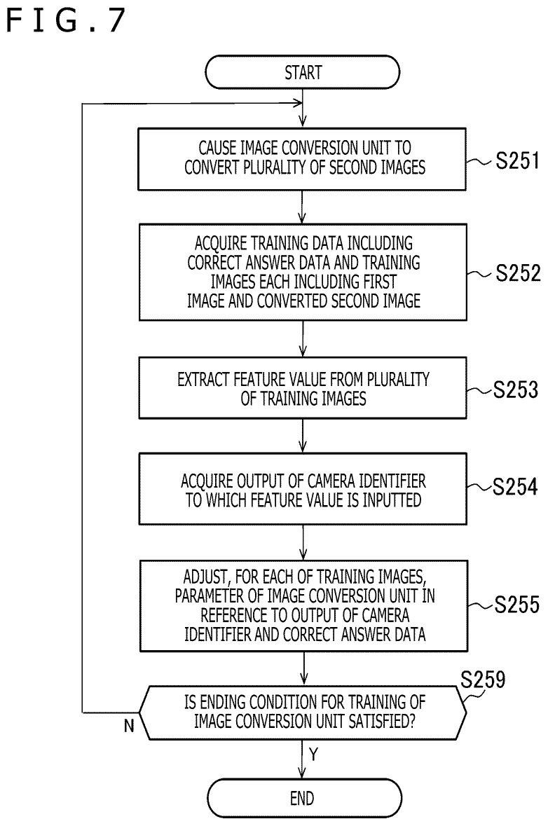

The process in S103 is described in more detail. FIG. 7 is a flow chart depicting an example of processing for training the image conversion unit 22.

First, the conversion training unit 31 causes the image conversion unit 22 to convert the second images included in the plurality of sets stored in the storage unit 12 (S251). Then, the conversion training unit 31 acquires training data including correct answer data and training images including the plurality of first images included in the plurality of sets and the plurality of converted second images (S252). The correct answer data is data indicative of which one of the first image and the second image the training image is.

Next, the first feature extraction unit 23a or the second feature extraction unit 23b extracts a feature value from each of the plurality of training images (S253). The difference detection unit 32 acquires an output of the camera identifier 33 to which the extracted feature value is inputted (S254). It is to be noted that, in the following description, the output of the camera identifier 33 regarding the first image as a training image is referred to as a first output, and the output of the camera identifier 33 regarding the second image as a training image is referred to as a second output.

Then, the conversion training unit 31 adjusts, for each of the training images, the parameter of the image conversion unit 22 in reference to the output of the camera identifier 33 and the correct answer data (S255). The conversion training unit 31 updates, in the adjustment of the parameter, the parameter such that the Binary Cross Entropy between the output of the camera identifier 33 and the true value increases. It is to be noted that the parameter may be updated by some other method such as the Mean Squared Error, for example. It is to be noted that, although, in the example of FIG. 7, the adjustment of the parameter is performed collectively for the first images and the second images, it may otherwise be performed at different timings.

After the parameter is adjusted, the conversion training unit 31 determines whether or not an ending condition for training of the image conversion unit 22 is satisfied (S259). In a case where the ending condition is not satisfied (N in S259), the processes beginning with S251 are repeated, but in a case where the ending condition is satisfied (Y in S259), the processing of FIG. 7 is ended. The ending condition may be that the number of times of repetition of the processing becomes equal to a number (Epoch number) determined in advance, or may be that the correct answer rate of the camera identifier 33 with respect to input data for a test becomes lower than a threshold value.

In the present embodiment, in a system in which extraction of a feature value is a premise, for the sake of training of the image conversion unit 22, instead of a first image and a converted second image being identified, a feature value extracted from a first image and a feature value extracted from a converted second image are being identified. In a case where the image conversion unit 22 trained by the method just described is used to perform processing that is premised on extraction of a feature value in regard to an image captured under a certain image capturing condition and an image captured under some other image capturing condition, it is possible for the image conversion unit 22 to convert an image more appropriately and suppress degradation of the accuracy of the process. Further, since the image conversion unit 22 can cope with this by relatively weak conversion of such a level as is required for extraction of a feature value, training is easy in comparison with making images themselves coincident with each other, and it is also possible to suppress occurrence of such a problem as distortion caused by strong conversion.

Further, since information is abstracted by extraction of a feature value, even in a case where the first camera 20a and the second camera 20b capture an object, for example, from positions and/or angles different from each other, it is possible to train the image conversion unit 22 appropriately.

The difference detection unit 32 determines the correctness of the output of the camera identifier 33 every time a first image or a converted second image is inputted to the camera identifier 33. Meanwhile, the camera identifier 33 is trained to identify a first image and a converted second image, and the identification is performed internally focusing on a characteristic that is different between the first feature value and the second feature value. Consequently, correct identification by the camera identifier 33 indicates that a difference in characteristics between the first feature value and the second feature value is detected appropriately. Accordingly, determination of the correctness of the output of the camera identifier 33 by the difference detection unit 32 corresponds to detection of a difference in characteristics between the first feature value and the second feature value.

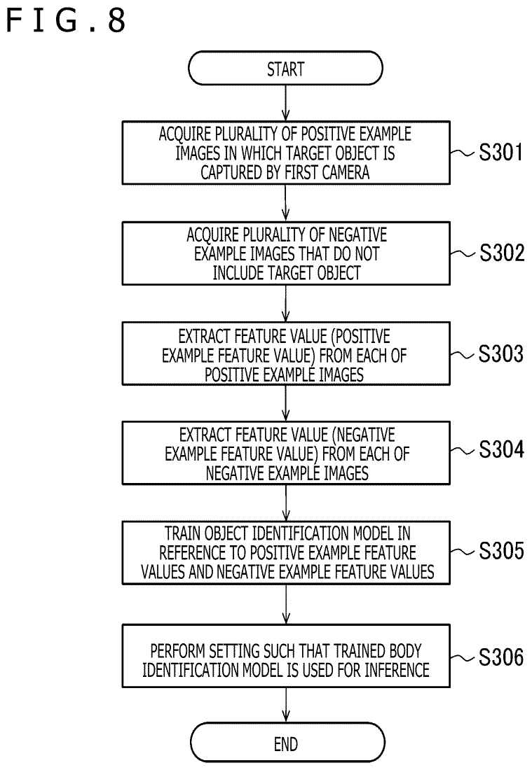

Now, an example of utilization of the trained image conversion unit 22 is described. FIG. 8 is a flow chart depicting an example of a training process of the object identification model 24 based on the first camera 20a. The processing depicted in FIG. 8 is an example of processing by the configuration depicted on the left side in FIG. 3 and is an example in a case in which an image for training of the object identification model 24 is captured by the first camera 20a.

First, the first image acquisition unit 21a acquires a plurality of positive example images in which a target object is captured by the first camera 20a (S301). The first image acquisition unit 21a acquires a plurality of negative example images that are captured by the first camera 20a and that do not include the target object (S302).

The first feature extraction unit 23a extracts a feature value (positive example feature value) from each of the positive example images (S303), and extracts a feature value (negative example feature value) from each of the negative example images (S304). Then, the object training unit 35 trains the object identification model 24 in reference to the positive example feature values and the negative example feature values (S305). The object training unit 35 performs setting such that the trained object identification model 24 is used for inference (S306). The setting may more particularly be copying the parameter of the trained object identification model 24 to the parameter of the object identification model 24 for inference or may be setting such that a feature value to be made a target of inference is inputted to the trained object identification model 24 itself.

It is to be noted that the positive example images may not be images captured by the first camera 20a but images captured by the second camera 20b and converted by the image conversion unit 22. The negative example images may be a mixture of images captured by the first camera 20a and images captured by the second camera 20b and converted by the image conversion unit 22. Even in such cases as just described, it is possible to train the object identification model 24 appropriately.

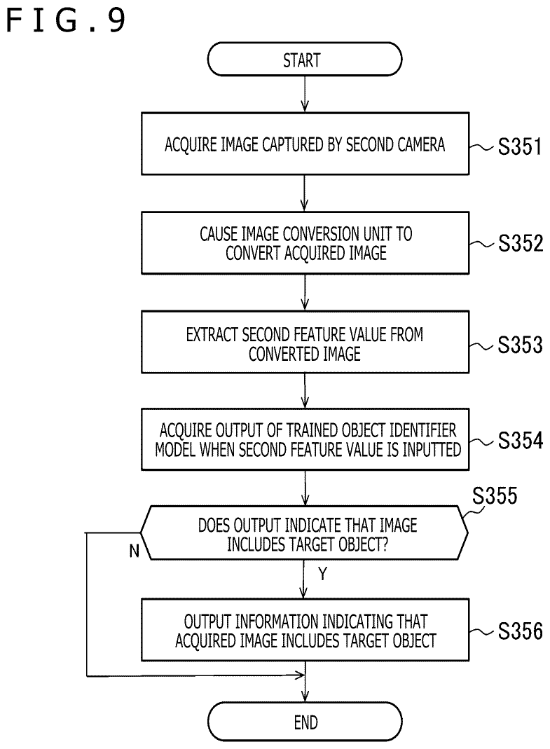

FIG. 9 is a flow chart depicting an example of an inference process based on the second camera 20b. FIG. 9 depicts an example of processing for determining whether or not an image captured by the second camera 20b with use of the trained object identification model 24 includes a target object, and also illustrates processing in a case where it is determined that an image captured by the second camera 20b includes a target object.

First, the second image acquisition unit 21b acquires an image captured by the second camera 20b (S351). The trained image conversion unit 22 converts the acquired image (S352). The second feature extraction unit 23b extracts a second feature value from the converted image (S353).

The processing unit acquires an output of the trained object identification model 24 when the second feature value is inputted thereto (S354). In a case where the output indicates that the acquired image includes a target object (S355), the processing unit outputs information indicating that the acquired image includes the target object (S356). The information indicating that the image includes the target object may be an image that is outputted to a display device or may be outputted as sound. It is to be noted that the processing unit may execute other processing according to the image including the target object.

Configuring the image conversion unit 22 taking extraction of a feature value into consideration in such a manner allows more appropriate conversion, making it possible for a difference in image capturing condition such as a difference in camera to be absorbed by the image conversion unit 22.

It is to be noted that, applying the present invention makes it possible to cope with a difference in image capturing condition other than a difference in camera, for example, a difference in light source upon image capturing and ambient light.

Further, particular character strings and numerical values given hereinabove and particular character strings and numerical values in the drawings are exemplary; such character strings and numerical values are not restrictive and may be altered as occasion demands.

1. An information processing system comprising:
a first image acquisition unit that acquires a first image in which a subject is captured under a first image capturing condition;
a second image acquisition unit that acquires a second image in which the subject is captured under a second image capturing condition;
an image conversion unit that is a machine learning model to which the acquired second image is inputted and which outputs a converted second image;
an extraction unit that extracts a first feature value indicative of a feature of the first image and a second feature value indicative of a feature of the converted second image from the second image converted by the image conversion unit; and
a conversion training unit that trains the image conversion unit in reference to a difference in characteristics between the first feature value and the second feature value in regard to a plurality of subjects.

2. The information processing system according to claim 1, wherein
the first image capturing condition is image capturing using a first camera, and
the second image capturing condition is image capturing using a second camera having a characteristic different from that of the first camera.

3. The information processing system according to claim 1, wherein the conversion training unit trains the image conversion unit in reference to a difference between a correct answer and a value outputted, when the first feature value or the second feature value is inputted to an identifier, from the identifier that is trained with learning data including a plurality of pieces of input data each including one of the first feature value and the second feature value and correct answer data indicative of which one of the first feature value and the second feature value each piece of the input data is.

4. The information processing system according to claim 1, further comprising:
a processing unit that inputs a feature value extracted by the extraction unit from the image captured under the second image capturing condition and converted by the image conversion unit to a machine learning model trained in reference to a feature value extracted by the extraction unit from the image captured under the first capturing condition and executes a process in reference to an output of the machine learning model in regard to the inputted feature value.

5. The information processing system according to claim 4, wherein the machine learning model outputs information indicative of whether or not the image captured under the second image capturing condition and converted by the image conversion unit includes a predetermined object.

6. An information processing method comprising:
acquiring a first image in which a subject is captured under a first image capturing condition;
acquiring a second image in which the subject is captured under a second image capturing condition;
extracting a first feature value indicative of a feature of the first image and a second feature value indicative of a feature of the second image converted by an image conversion unit that is a machine learning model to which the acquired second image is inputted and which outputs a converted second image; and
training the image conversion unit in reference to a difference in characteristics between the first feature value and the second feature value in regard to a plurality of subjects.

7. A non-transitory, computer readable storage medium containing a computer program, which when executed by a computer, causes the computer to execute an information processing method by carrying out actions, comprising:
acquiring a first image in which a subject is captured under a first image capturing condition;
acquiring a second image in which the subject is captured under a second image capturing condition;
extracting a first feature value indicative of a feature of the first image and a second feature value indicative of a feature of the second image converted by an image conversion unit that is a machine learning model to which the acquired second image is inputted and which outputs a converted second image; and
training the image conversion unit in reference to a difference in characteristics between the first feature value and the second feature value in regard to a plurality of subjects.
